(19) United States
(12) Patent Application Publication
(10) Pub. No.: US 2016/0097933 A1
(43) Pub. Date: Apr. 7, 2016

(54) DISPLAY SYSTEM WITH SEMI-TRANSPARENT SCREEN SHARED BY TWO OBSERVERS

(71) Applicant: THALES, Courbevoie (FR)

(72) Inventors: Philippe CONI, St Jean d'Illac (FR); Sylvain Hourlier, Bordeaux (FR); Sebastien Ellero, Andiran (FR)

(21) Appl. No.: 14/874,363

(22) Filed: Oct. 2, 2015

(30) Foreign Application Priority Data
Oct. 3, 2014 (FR) 1402244

(51) Int. Cl. G02B 27/22; G02B 27/26; H04N 9/31

(52) U.S. Cl. CPC G02B 27/2228; H04N 9/3179; G02B 27/26

(57) ABSTRACT

The general field of the invention is that of display systems comprising means for generating images of a predetermined object and a display device comprising a semi-transparent projection screen. The system according to the invention is intended to be used simultaneously by at least two observers. The image generating means comprise features arranged to generate a first image of a first object and a second image of a second object, and the display system comprises two pairs of glasses worn by the first and second observer, arranged such that the first observer sees only the first image and not the second image and the second observer sees only the second image and not the first image, each pair of glasses allowing the exterior light to pass through. The first object and the second object may be identical.

The scope of the invention is that of display systems enabling an image to be superimposed on the outside world. In a certain number of applications, piloting and navigation are ensured by at least two crew members. These two crew members may be lead to simultaneously look at the same display screens and it may be necessary to differentiate the images seen by each of the two crew members.

The invention is particularly applicable to the field of aircraft cockpits where both pilots need to observe the outside landscape and the aircraft's flight and navigation information. The invention can also be applied to all types of operating and control systems superimposing symbols on a natural outdoor environment. This is the case, for example, with control towers and ship's bridges. The outdoor environment can also be simulated. This is notably the case with drone monitoring and control platforms and flight simulators.

The simplest way to superimpose a digital image on a landscape consists in projecting or forming the image on a semi-transparent screen placed in front of the pilot(s). This solution has the advantages of being able to cover a large surface area and to project an image in a wide field of view, unlike collimated display systems for which the pupil is, by nature, necessarily limited.

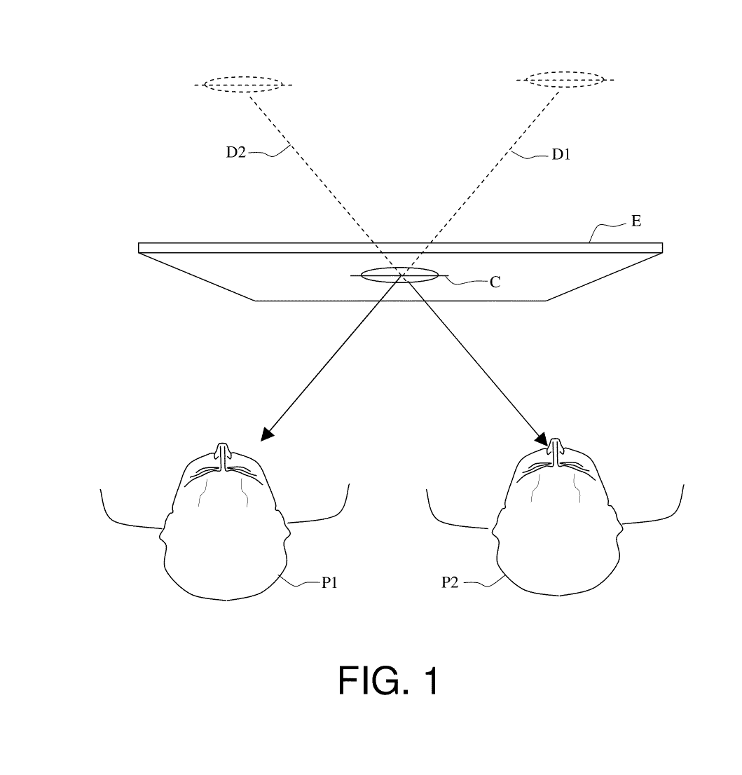

However, in principle, the projected image is at a finite distance and superposition on the outside is thus not perfect. If the pilot moves his head, the projected image changes position relative to the outdoor landscape. This problem becomes critical when the screen is viewed by two users, necessarily separated a certain distance and with different points of view. In this case, the image seen by the first user is superimposed on an area of the outdoor landscape that is completely different from that seen by the second user. FIG. 1 illustrates this problem. In this figure, a barred circle I is projected onto a display screen E. The projection means are not shown in this figure. The first user P1 sees this circle in a first direction D1 while the second user P2 sees this circle in a second direction D2, totally different from D1. More generally, the information seen by the first crew member is not necessarily the same as that seen by the second crew member.

The system according to the invention does not have these drawbacks. It comprises means for generating at least two different images, the first one intended for the first pilot only and the second one for the second pilot only. More precisely, the invention relates to a display system intended to be used simultaneously by at least two observers, said system comprising means for generating predetermined images of objects and a display device having a semi-transparent projection screen on which the images of said predetermined objects are formed, wherein:
the image generating means comprise features arranged to generate a first image of a first object and a second image of a second object;
the display system comprises two pairs of glasses worn by the first and second observer, arranged so that the first observer sees only the first image and not the second image and so that the second observer sees only the second image and not the first image, each pair of glasses letting outside light pass through;
the display system comprises means for detecting the relative position of each pair of glasses with respect to the position of the semi-transparent screen, and means for calculating the first image and the second image such that the first observer located at a first distance from the semi-transparent screen sees a first image of the object corresponding to a first predetermined position and such that the second observer located at a second distance from the semi-transparent screen sees the second image corresponding to a second predetermined position.

Advantageously, when the second object is identical to the first object, the second predetermined position is identical to the first predetermined position.

Advantageously, each pair of glasses comprises two lenses, each lens being dedicated to one eye; the first lens blocks the first image and the second image, the second filter lens blocks only the first image and transmits the second image or vice versa.

Advantageously, the display device operates in sequential mode, the first image and the second image being transmitted alternately, each pair of glasses comprising means arranged so that the transparency of one of the two lenses varies from transparent to opaque in a synchronous manner with the emission of the two images.

Advantageously, the projector comprises means arranged to alternately project a first image emitted at one and only one first wavelength and a second image transmitted at one and only one second wavelength different from the first wavelength, the first pair of glasses comprising a first filter transmitting the entire spectrum except for a first narrow spectral band centred on the first wavelength and the second pair of glasses comprising a second filter transmitting the entire spectrum except for a second narrow spectral band centred on the second wavelength.

Advantageously, the projector comprises means arranged to alternately project a first image emitted in three first spectral bands and a second image emitted in three second spectral bands different from the first spectral bands, the first pair of glasses comprising a first filter transmitting the entire spectrum except for the first three spectral bands and the second pair of glasses comprising a second filter transmitting the entire spectrum except for the three second spectral bands.

Advantageously, the display system is an aircraft cockpit system.

The invention will be better understood and other advantages will become apparent upon reading the description which will follow, given by way of non-limiting example and from the appended figures among which:

FIG. 1, mentioned above, represents a display system of the prior art;

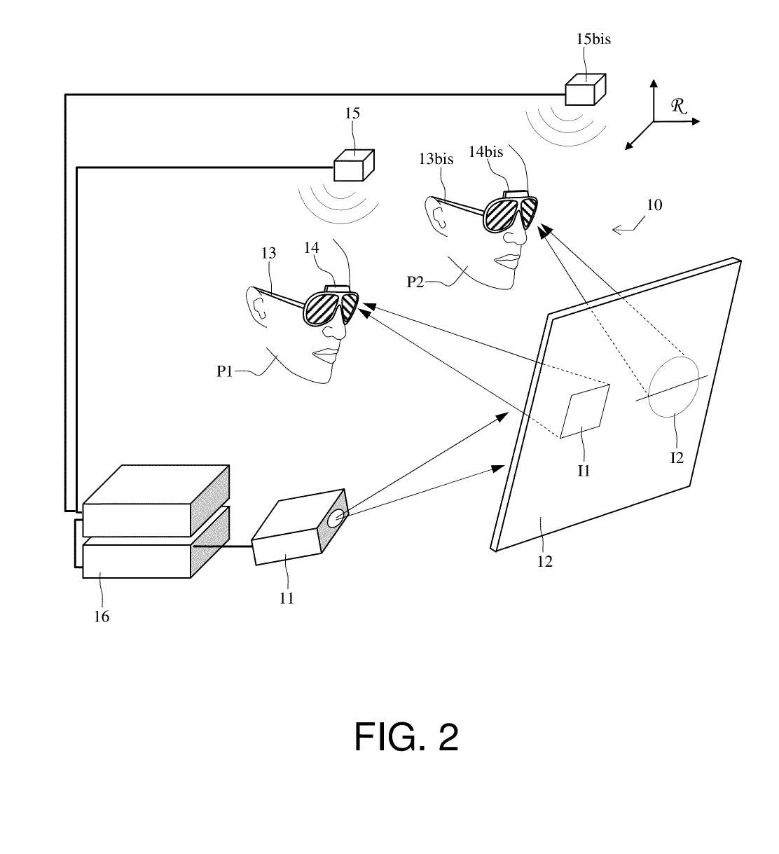

FIG. 2 represents an architecture of a display system according to the invention dedicated to two observers;

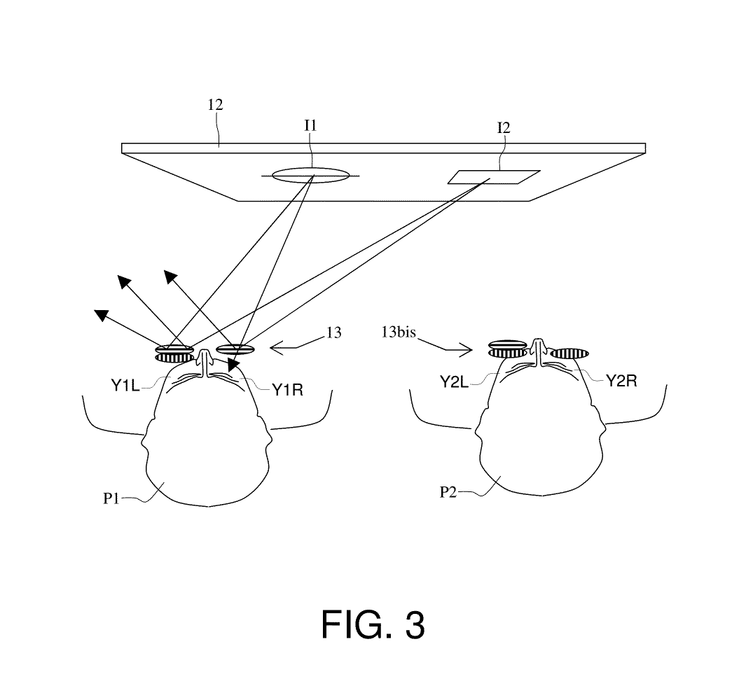

FIG. 3 represents a first operating mode of a display system according to the invention;

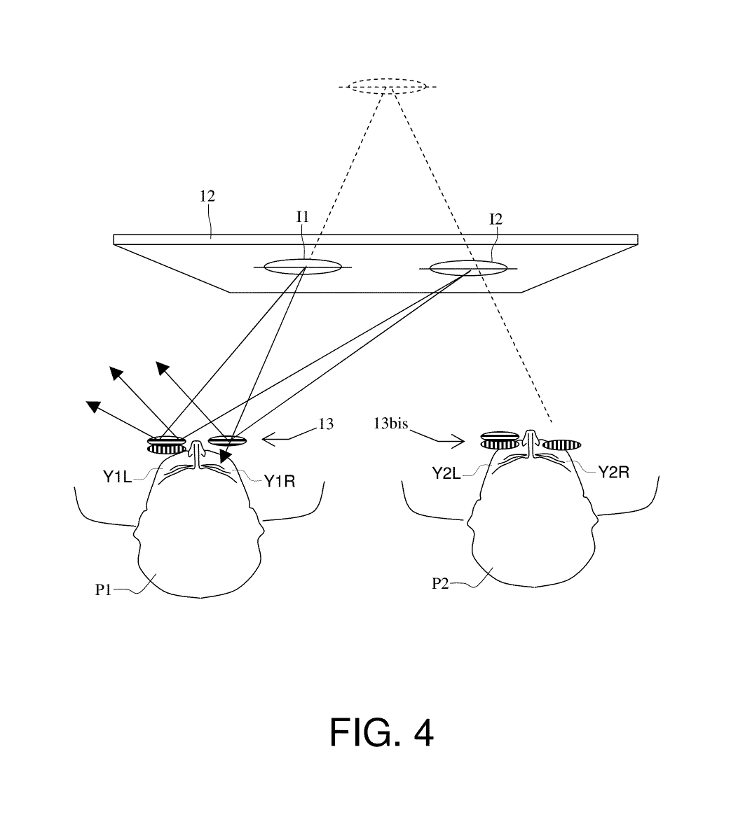

FIG. 4 represents a second operating mode of a display system according to the invention.

For example, a display system 10 according to the invention is shown in FIG. 2. It is intended to operate for two users, identified as P1 and P2 in FIG. 2.

It is easy to adapt this system to operate with more than two observers. The display system thus comprises features similar to those of a system with two observers, but adapted to the number of observers. For example, if the system must operate with three observers P1, P2 and P3, then the system comprises features such that the pair P1 and P2 does not see the same thing, the pair P1 and P3 does not see the same thing and the pair P2 and P3 does not see the same thing. In this case, each observer sees only the intended information. However, in the case of onboard aeronautical applications, observation by two crew members is the most frequent case.

The display system shown in FIG. 2 includes:
An image projector 11 able to generate at least two representative images I1 and I2, either two different objects, or the same object, the first image I1 intended for the first user P1 and the second image I2 intended for the second user P2. In the case of FIGS. 1, 2 and 3, the objects are different and represent a barred circle and a square seen in perspective;
A semi-transparent display screen 12 on which the two images are projected;
A first pair of glasses 13 worn by the first user P1, comprising:
   means for selecting images so that the first user sees only the first image I1 and the outdoor landscape, and;
   first detection means 14;
second detection means 15 connected to a fixed reference [symbol]
   and which, associated with the first detection means 14 enable the detection of the spatial position of the pair of glasses 13 in this fixed reference;
A second pair of glasses 13bis worn by the second user P2, comprising:
   means for selecting images so that the second user sees only the second image I2 and the outdoor landscape, and;
   first detection means 14bis;
second detection means 15bis connected to the same fixed reference [symbol] and which, associated with the first detection means 14bis enable the detection of the spatial position of the pair of glasses 13bis in this fixed reference;
An electronic controller 16 comprising at least the following functions:
   Acquisition of the signals from the detection means 14, 14bis, 15 and 15bis and calculation of the position of the two pairs of glasses 13 and 13bis;
   Calculation of the position of the two images I1 and I2 corresponding to the positions of the two pairs of glasses;
   Calculation of the two images I1 and I2 based on said positions.

The image projector 11 comprises high-resolution projection optics with magnification adapted to the size of the projection screen. For aeronautical applications, it is important that the maximum brightness of the display unit can be very high. The images are encoded by the display unit so that they can be separated by the pair of glasses 13 and 13bis.

The semi-transparent screen 12 is an optical plate having both semi-transparency of the outdoor landscape and a diffusion of images. For this purpose, the surface of the projection screen can comprise a network of diffusing patterns. The screen is diffused over a wide viewing angle, next to the half space. Thus, a large eye box enabling proper use by two users who are necessarily separated by a certain distance. The term “eye box” refers to the zone of the space where the images are visible. This solution also allows perfect control of the screen's transparency. Thus, if the patterns cover only a limited percentage of the screen's surface, the transmission of the screen is equal to one minus the percentage covered by the patterns. For example, if the patterns cover 20% of the surface, the screen transmission is close to 80%.

As previously mentioned, the system is arranged so that each user can see only the image he/she is intended to see. This single image can be seen by both eyes of the user. However, to obtain a good superposition on the outdoor landscape, it must preferably be stereoscopic. It is thus necessary to emit four different images, two first stereoscopic images intended for the first user and two second stereoscopic images intended for the second user. At all times, each eye must only see one of the four images emitted.

It is also possible for the system to operate in monocular vision. Each user thus sees the image from the projector with one single eye. Consequently, as illustrated in FIGS. 3 and 4, a first user P1 must see:
the outdoor landscape with both eyes, noted Y1L and Y1R in FIG. 3;
image I1 which is intended for one single eye. In the case of FIG. 3, it is the eye Y1R;
image I2 is not intended to be seen with either of the two eyes Y1L and Y1R.

The light rays are represented by arrows in FIG. 3. The same reasoning can be applied to eyes Y2L and Y2R of the second user P2.

In the case of FIG. 3, the two objects are different. The first observer, located a first distance from the semi-transparent screen, sees the first image of the first object corresponding to a first predetermined position and the second observer, located a second distance from the semi-transparent screen, sees the second image corresponding to the second predetermined position. The detection means of the relative position of each pair of glasses in relation to the position of the semi-transparent screen associated with electronic controller are used to calculate the positions of the first image and the second image so as to obtain these two predetermined positions.

In the case of FIG. 4, this is the same object. In the latter case, the predetermined position of the object is common to both observers as seen in this figure.

There are different optical means to ensure these image selection functions. Generally, they are separated into two large categories depending on whether the glasses are “active” or “passive”. Active glasses are glasses for which an optical parameter, generally transmission, varies over time.

In the first case, the stereoscopic projector operates in sequential mode. It successively and periodically emits an image intended for the first user, and an image intended for the second user. The lenses of each pair of glasses are transparent during the first emission sequence and opaque during the second sequence. This solution has the advantage of being able to adapt to both monoscopic vision and stereoscopic vision. It is thus possible, with a single projector, to supply two pairs of different stereoscopic images, the first pair of images intended for the first pair of glasses 13 and the second pair of images intended for a second pair of glasses 13bis. The transmission variations of the lenses in the glasses are ensured by using, for example, active LCD lenses or mechanical micro-switches or “shutters”. One of the advantages of this solution is that it is possible to increase the transmission of the outdoor landscape by not displaying symbology between two display cycles. In this case, in the absence of a displayed image, all the lenses of the glasses are rendered clear.

In the second case, various techniques exist to render passive glasses selective. It is thus preferable to work in monocular vision to optimise the transmission of the outdoor landscape. As a first example, the system works in polarised light. The projector successively and periodically emits a first image according to a first polarisation and a second image according to a second polarisation, different from the first polarisation. The pairs of glasses 13 and 13bis comprise at least a first polarised lens that is transparent to the first polarisation and opaque to the second polarisation.

Spectral selection of the projected images is also possible. In this technical solution, the projector emits two coloured images whose emission spectra are separated. Each pair of glasses has at least one different filter, the first filter of the first pair transmits the first spectrum and filters the second spectrum. The second filter of the second pair performs the opposite function. Thus, each user sees one single coloured image and only that image. The term anaglyph is used to describe this technique. In monoscopic vision, the first lens of the glasses comprises only one of the two filters and the second lens of the glasses comprises both filters or one filter covering the two spectrums so as to completely eliminate the two images.

Anaglyphs can be monochrome or coloured. The easiest way to achieve a monochromatic anaglyph is to use two adjacent wavelengths emitting, for example, in the green range of the visible spectrum. In this case, the projector comprises means for sequentially illuminating the display unit at the first, then at the second wavelength. These means are either laser diodes, or filtered LEDs, or a white or multispectral filtered light source.

More sophisticatedly, the so-called spectral multiplexing system separates the visible spectrum into two interlaced parts, one dedicated to each user. Coloured images can thus be obtained. The colourimetry of the landscape is better preserved.

The system for detecting the position of each pair of glasses conventionally comprises two sub-assemblies, the first sub-assemblies 14 and 14bis are secured to the two pairs of glasses, the second sub-assemblies 15 and 15bis are arranged in a fixed reference frame.

There are various techniques for identifying an object in space. Electromagnetic detection can be used. A transmitter is arranged in the fixed reference frame and a receiver is placed in the mobile reference frame. Passive or active optical detection can also be used. In the latter case, the pair of glasses bears light-emitting diodes whose emission position is identified by cameras. All these techniques are known to those skilled in the art. They are compatible with real-time operation and adapt easily to the display system according to the invention.

When the user moves his head, these movements are captured by the detection means of the pairs of glasses. The electronic controller then recalculates the position of the images in real time so that users continue to see the virtual images of objects in the same place. As a simple example, if the virtual image of an object is at infinity, the monocular images are separated by a distance which is substantially equal to the average distance between the two users. Their movement on the display screen is substantially equal to that of the pair of glasses. This thus creates the sensation of an infinite image.

The technical applications of the display system according to the invention mainly relate to vehicle operating assistance. The system according to the invention is particularly applicable to the field of aircraft instrument panels. In this case, the crew is necessarily comprised of two crew members who need to see outside and also be aware of the aircraft's flight and navigation information. The application in the field of helicopters is particularly advantageous insofar as helicopters have large canopies in which large screens can be installed. Moreover, helicopters fly at low altitude.

The application in the field of control towers, control stations or ship's bridges is particularly interesting since these positions consist of numerous glass surfaces enabling multiple outside environments to be monitored in order to detect and/or control critical objects.

1. A display system intended to be used simultaneously by at least two observers, said system comprising means for generating predetermined images of objects and a display device having a semi-transparent projection screen on which the images of said predetermined objects form, wherein:
the image generating means comprise features arranged to generate a first image of a first object and a second image of a second object;
the display system comprises two pairs of glasses worn by the first and second observer, arranged such that the first observer perceives only the first image and not the second image and such that the second observer perceives only the second image and not the first image, each pair of glasses letting outside light pass through;
the display system comprises means for detecting the relative position of each pair of glasses with respect to the position of the semi-transparent screen, and means for calculating the first image and the second image such that the first observer located at a first distance from the semi-transparent screen sees a first image of the object corresponding to a first predetermined position and such that the second observer located at a second distance from the semi-transparent screen sees the second image corresponding to a second predetermined position.

2. The display system according to claim 1, wherein, when the second object is identical to the first object, the second predetermined position is identical to the first predetermined position.

3. The display system according to claim 1, wherein each pair of glasses comprises two lenses, each lens being dedicated to one eye; the first lens blocks the first image and the second image, the second filter lens blocks only the first image and transmits the second image or vice versa.

4. The display system according to claim 1, wherein the display device operates in sequential mode, the first image and the second image being transmitted alternately, each pair of glasses comprising means arranged so that the transparency of one of the two lenses varies from transparent to opaque in a synchronous manner with the emission of the two images.

5. The display system according to claim 1, wherein the projector comprises means arranged to alternately project a first image emitted at one and only one first wavelength and a second image transmitted to one and only one second wavelength different from the first length wave,
the first pair of glasses comprising a first filter transmitting the entire spectrum except for a first narrow spectral band centred on the first wavelength and the second pair of glasses comprising a second filter transmitting the entire spectrum except for a second narrow spectral band centred on the second wavelength, the first spectral band and the second spectral band not overlapping.

6. The display system according to claim 1, wherein the projector comprises means arranged to alternately project a first image transmitted in the first three spectral bands and a second image emitted in three second spectral bands different from the first spectral bands,
the first pair of glasses comprising a first filter transmitting the entire spectrum except for the first three spectral bands and the second pair of glasses comprising a second filter transmitting the entire spectrum except for the three second spectral bands.

7. The display system according to claim 1, wherein the display system is an aircraft cockpit system.
